(19) United States
(12) Patent Application Publication
(10) Pub. No.: US 2016/0378734 A1
(43) Pub. Date: Dec. 29, 2016

(54) VISUALIZING DOCUMENT REVISIONS

(71) Applicant: Microsoft Technology Licensing, LLC, Redmond, WA (US)

(72) Inventors: Christopher Lee Mullins, Sammamish, WA (US); Jonathan Edgar Fay, Woodinville, WA (US)

(21) Appl. No.: 14/754,353

(22) Filed: Jun. 29, 2015

(51) Int. Cl. G06F 17/22; G06F 3/0485; G06F 17/21; G06F 3/0484; G06F 17/24

(52) U.S. Cl. CPC G06F 17/2288; G06F 3/04847; G06F 3/04845; G06F 17/241; G06F 17/218; G06F 3/04855; G06F 17/212; G06F 17/2229

(57) ABSTRACT

A facility for servicing a request for a document is described. The facility receives the request, which identifies the document and specifies a time for which the document is to be constituted. In response to receiving the request, the facility accesses information representing a number of editing actions performed on the identified document. The accessed information indicates, for each of the represented editing actions, a time at which the editing action was performed on the identified document. The facility responds to the request with a version of the identified document that reflects all of the represented editing actions whose indicated time is before the specified time, and that reflects none of the represented editing actions whose indicated time is after the specified time.

### BACKGROUND

Electronic documents can contain content such as text, images, and spreadsheets. Electronic documents can be revised over a significant period of time by multiple people. Some document-editing applications—such as certain word processors—track revisions made to the document by different users, storing them in the file that constitutes the document and displaying the full set of them using redlining—underlining formatting for materialized content, and struck-through formatting for deleted content.

### BRIEF DESCRIPTION OF THE DRAWINGS

FIG. 1 is a network diagram showing the environment in which the facility operates in some embodiments.

FIG. 2 is a block diagram showing some of the components typically incorporated in at least some of the computer systems and other devices on which the facility operates.

FIGS. 3-5 are display diagrams showing the editing and display of a document incorporating a shared document fragment.

FIG. 6 is a flow diagram showing steps typically performed by the facility in some embodiments in order to incorporate a document fragment into a document, and adjust the mode of its incorporation.

FIG. 7 is a flow diagram showing steps typically performed by the facility in some embodiments in order to materialize a document containing shared fragments.

FIG. 8 is a table diagram showing sample contents of a fragment directory table used by the facility in some embodiments to store information about fragments.

FIG. 9 is a table diagram showing sample contents of a fragment version table used by the facility in some embodiments to store information about fragment versions.

FIG. 10 is a table diagram showing sample contents of a fragment version instance table used by the facility in some embodiments to store information about fragment version instances.

FIG. 11 is a table diagram showing sample contents of a fragment version instance content table used by the facility in some embodiments to store fragment version instance content.

FIG. 12 is a flow diagram showing steps typically performed by the facility in some embodiments to record a document revision history for a document being edited.

FIG. 13 is a table diagram showing sample contents of a document revision history table used by the facility in some embodiments to store document revision histories for one or more documents.

FIG. 14 is a flow diagram showing steps typically performed by the facility in some embodiments in order to materialize a document at an arbitrary point in time after its creation.

FIG. 15 is a flow diagram showing steps typically performed by the facility in some embodiments to create a new document fragment for each editing action performed on a document.

FIG. 16 is a table diagram showing sample contents of a fragment version table reflecting creation by the facility in some embodiments of a new document fragment version for each editing action performed with respect to the fragment or other document.

FIG. 17 is a flow diagram showing steps typically performed by the facility in some embodiments in order to materialize a document at an arbitrary point in time after its maintenance using per-editing action fragment versions.

FIG. 18 is a flow diagram showing steps typically performed by the facility in some embodiments in order to display a varying state of a document in response to user interactions with a timeline user interface control.

FIG. 19 is a display diagram showing a sample display presented by the facility in some embodiments in which the timeline is in an initial state.

FIG. 20 is a display diagram showing a sample display presented by the facility in some embodiments in which the timeline in an initial state is displayed in an alternate form.

FIG. 21 is a display diagram showing a sample display presented by the facility in some embodiments in which the timeline is in an initial state having annotations showing which section of the document were edited on which days.

FIG. 22 is a display diagram showing a sample display presented by the facility in some embodiments in which the timeline is in an initial state having annotations showing which authors edited the document at different points in time.

FIG. 23 is a display diagram showing a sample display presented by the facility in some embodiments in which the user has moved the timeline slider.

FIG. 24 is a display diagram showing a sample display presented by the facility in some embodiments in which the user has manipulated the zoom control.

FIG. 25 is a flow diagram showing steps typically performed by the facility in some embodiments in order to enable a user to use the timeline to specify a period of time during which editing actions are to be shown within the document.

FIG. 26 is a display diagram showing a sample display presented by the facility in some embodiments in order to enable a user to use the timeline to specify a period of time during which editing actions are to be shown within the document.

FIG. 27 is a display diagram showing a sample display presented by the facility in some embodiments to show the state of a document's fragment graph at a first time.

FIG. 28 is a display diagram showing a sample display presented by the facility in some embodiments to show the state of a document's fragment graph at a later time.

FIG. 29 is a flow diagram showing steps typically performed by the facility in some embodiments in order to generate analytics from document revision histories for a corpus of documents.

### SUMMARY

This summary is provided to introduce a selection of concepts in a simplified form that are further described below in the Detailed Description. This summary is not intended to identify key factors or essential features of the claimed subject matter, nor is it intended to be used to limit the scope of the claimed subject matter.

A facility for servicing a request for a document is described. The facility receives the request, which identifies the document and specifies a time for which the document is to be constituted. In response to receiving the request, the facility accesses information representing a number of editing actions performed on the identified document. The accessed information indicates, for each of the represented editing actions, a time at which the editing action was performed on the identified document. The facility responds to the request with a version of the identified document that reflects all of the represented editing actions whose indicated time is before the specified time, and that reflects none of the represented editing actions whose indicated time is after the specified time.

### DETAILED DESCRIPTION

### Overview

The inventors have recognized significant disadvantages in conventional approaches to visualizing document revisions. In particular, these conventional approaches tend to blur together revisions made over significant periods of time, such that it is difficult or impossible to discern the order in which revisions were made, determine how far apart in time revisions were made, or view the contents of the document at a particular point in time.

In order to overcome these disadvantages, the inventors have conceived and reduced to practice a software and/or hardware facility for visualizing document revisions (“the facility”). For a document whose revisions are to be visualized, the facility maintains a complete history of editing actions performed on the document, attributing to each an author identity and a timestamp. By using this complete history, the facility can respond to a request to display the state of the document at any time since the document's creation.

In some embodiments, the facility displays a timeline slider that the user can manipulate to select any time since the document's creation. This is sometimes described as “materializing a timeline slider view” over the document. In response, the facility displays the state of the document at that moment in time. In some embodiments, as the user moves the timeline's slider, the state of the document displayed is continuously updated. In some embodiments, the facility displays controls that allow the user to scroll and zoom the timeline to select different periods within the document's lifetime to display. In some embodiments, the facility displays along with the timeline a document lifetime timeline that shows the entire lifetime of the document and the particular period during the lifetime of the document that is presently selected for display.

In various embodiments, the facility annotates the timeline in various ways. For example, in some embodiments, the facility annotates the timeline to show points in time at which editing actions occurred. These annotations make it easy for a user to identify periods during which the document was being worked on vigorously and/or being changed significantly, as contrasted with periods during which the state of the document was stable. In various embodiments, these annotations visually reflect the authors performing the editing actions at each time, the different portions of the document within which the editing actions were performed at each time, a relative or absolute volume of editing actions performed at that time, etc. In various embodiments, the facility tracks various other actions or events affecting documents, such as viewing a document, sharing a document, approving a document, etc.

In some embodiments, the facility enables the user to select a proper subset of a document's editing actions, and display these in the context of the document via redlining or other kinds of visual revision indications. In some such embodiments, the user can filter the displayed editing actions by manipulating the facility's timeline to select a time range within the document's history. In some such embodiments, the user can filter the displayed editing actions to those performed by one or more authors, or one or more groups of authors.

In some embodiments, for a corpus of documents, such as documents generated on behalf of an organization or a portion of an organization, the facility analyzes the revision histories of these documents to generate various analytics measures, such as the documents or portions of documents that are being most vigorously revised during a particular period versus most stable during a period; the authors who are the most prolific or least active during the period, the overall productivity of the organization or portion of the organization during one period as compared to one or more others, etc.

In various embodiments, the facility represents documents and their revisions in various ways. In some embodiments, the facility stores a new version of the document for each editing action performed on the document, noting the author who performed the editing action and the time at which it was performed. In these embodiments, in order to display the state of the document at a particular time, the facility simply retrieves the version of the document that reflects the latest editing action that is no later than that time. In some embodiments, the facility represents the document solely as a series of editing actions performed beginning at the time the document was created, when the document was empty, again noting the author who performed the editing action and the time at which it was performed. In these embodiments, in order to display the state of the document at a particular time, the facility begins with an empty document, then performs all of the editing actions that occurred before that time. In some embodiments, the facility stores different versions of the document at various points in time, and also stores, for each adjacent pair of versions, the editing actions that occurred between that pair of versions. In these embodiments, in order to display the state of the document at a particular time, the facility begins with the latest version of the document before that time, and applies the editing actions performed between that version and the next one, except for those editing actions that occur after that time.

In some embodiments, the facility stores documents using a construct called a “document fragment,” or simply “fragment,” which is a unit of document content represented separately by the facility. The document is comprised of a single “root fragment,” which can directly contain content, as well as containing fragment references referring to other fragments. Those fragments referred to by the root fragment can themselves directly contain content and fragment references to other fragments, and so on. When a document is opened, the facility typically collects and synthesizes its contents by retrieving the root fragment, retrieving other fragments referred to by fragment references in the root fragment, retrieving further fragments referred to by fragment references in those fragments, and so on. In some embodiments, any fragment can be treated as a document, in the sense that it can be opened by an editing or presentation application as the root fragment.

In some embodiments, the facility stores the fragments making up users' documents in a cloud-based service, where they can be accessed from virtually any location. In some embodiments, this cloud-based service uses a technique called “erasure coding” in which it decomposes, or “shreds,” a fragment defined by a document author into multiple smaller constituent pieces, or “shreds,” each of which the facility stores on multiple storage devices in different data centers in different geographic locations to provide disaster and outage survivability. When the cloud-based service receives a request for a fragment, it retrieves and combines these shreds to reconstitute the fragment.

In some embodiments, the facility stores a new version of a fragment to reflect each editing action performed on the fragment, each identified by the date and time at which the editing action was performed. For example, in some embodiments, the facility creates a new fragment version for each character or group of characters that is materialized in the fragment—such as by a keystroke or a text block paste—and for each character or group of characters that is deleted—such as by a backspace keypress or a select-and-delete operation. In some embodiments, each fragment version identifies the author that took the editing action reflected by the fragment version. In some embodiments, after being written, these fragment versions cannot be altered, and are said to be “immutable.”

In some embodiments, over time, the facility deletes some of the versions of a fragment, so as to collapse two or more editing actions into an undeleted version of the fragment. In some embodiments, in doing so, the facility deletes only contiguous fragment versions all reflecting editing actions by the same author and immediately preceding an undeleted fragment version also reflecting an editing action by the same author.

In some embodiments, where the content is incorporated from a fragment-aware source document, the facility ensures that the incorporated content corresponds precisely to one or more whole fragments; that is, where the selected content spans only a portion of a fragment in the source document, the facility breaks that fragment in the source document into two fragments, a first that contains only the content from the original fragment that was selected, a second containing the content from the original fragment that was not selected, so that the first can be incorporated into the target document while the second is not. Where the content is incorporated from a fragment-unaware source document, the facility creates a new fragment to contain the incorporated content.

In response to the incorporation operation, the facility creates a fragment reference in the target document at the position in the target document where the content was incorporated to represent the incorporated content in the target document. In some embodiments, the fragment reference contains multiple components, such as a current fragment ID component and/or an original component. The current fragment ID component of the created fragment reference identifies the fragment to which the reference refers, such as by containing a fragment ID for this fragment that can be used to retrieve this fragment. The origin component, where used by the facility, maintains in the fragment reference state the fragment ID of the fragment in which the incorporated content originated, which can serve as a basis for changing the mode in which the incorporated content is used in the target document throughout the life of the fragment reference, and for tracking the provenance of the fragment. In some embodiments, the facility stores an ordered list of fragment IDs in the origin component to reflect the series of fragments from which the referenced fragment has been forked.

In various embodiments, at the time the user performs the incorporation operation, the user can specify an initial mode for the incorporated content in the target document by, for example, holding down a certain keyboard key during the drag interaction, using a varying control key combination to paste the incorporated content into the target document, responding to a context menu or dialog displayed by the facility in response to the incorporation operation, etc. In some embodiments, each mode has two characteristics: (1) whether the contents of the fragment are editable in the context of the incorporating document or fragment (“editable in context”) and (2) how a version of the referenced fragment is chosen for inclusion in the incorporating document or fragment (“version selection”). In some embodiments, the following kinds of version selection options are available: (a) “latest”—the version of the fragment with the most recent time is incorporated by the reference; (b) “time-specified”—a particular version of the fragment associated with a particular time is incorporated by the reference (e.g., in some embodiments, an arbitrarily specified time causes selection of the fragment version whose time is the latest among the fragments that are not later than the specified time); (c) “special”—special rules are used to specify which version of the fragment is selected for incorporation. Examples of special rules are the latest document approved by a qualified approval authority, or the earliest version embodying an edit by a particular author.

In various embodiments, the facility supports some or all of the following incorporation modes: live mode, follow mode, forkable mode, pinned mode, special forkable mode, and special follow mode.

Live mode (1) is editable in context and (2) uses “latest” version selection. Thus, in live mode, an author can change the content of the fragment, which results in a new version of the fragment being created to reflect each such change. These changes will appear in any other containing fragments that incorporate the same fragment, and whose version selection option ends up selecting this version, either (a) latest, or (b) special with a selection rule that selects this version. Live mode is typically used for a reference included to both revise the referenced fragment, and reflect the revisions of others. By virtue of using the latest version selection option, a reference in live mode incorporates the latest version of the fragment, no matter its content or which authors' revision it reflects. Where live mode is selected, the facility populates a current fragment ID component of the fragment reference with the same fragment ID as the origin component. The current component of the fragment reference identifies the fragment whose contents are to be retrieved for inclusion in the target document.

Follow mode (1) is not editable in context, and (2) uses latest version selection. In follow mode, the latest version of the fragment is always incorporated, but can't be edited in the context of the document or fragment containing the follow mode reference. Follow mode is typically used to incorporated dynamic content maintained by one or more other authors, in a centralized manner.

Forkable mode (1) is editable in context, and (2) uses time-specified version selection. In forkable mode, the fragment can be edited in the context of the reference from the fragment's state at the specified time. Performing such an edit transforms the reference from forkable mode to live mode; reflects the edit in the first version of a new fragment ID; stores the new fragment ID in the context of the reference; and stores the original fragment ID in the reference's origin component. Forkable mode is typically used where a particular state of a fragment is to be the basis for a new set of edits that won't affect documents or fragments incorporating the original fragment. Similarly, the forkable and resulting live reference aren't affected by edits to the original fragment subsequent to the forkable reference version selection time.

Pinned mode (1) is not editable in context, and (2) uses time-specified version selection. While the fragment reference is in pinned mode, the incorporated content cannot be changed, either by a user editing the document or fragment containing the pinned reference (because not editable in context precludes editing by such an author), or by a user editing the fragment in the context of a different containing document or fragment (because such edits will be reflected in a new version of the fragment, which will not be selected by the time-specified selection logic of this reference). Where pinned mode is selected, the facility populates the current component of the fragment reference with the fragment ID of the origin fragment. Pinned mode is typically used to preserve a particular state of the fragment in the referring document.

Special forkable mode (1) is editable in context, and (2) specifies a special version selection rule. The incorporated fragment will, at any given time, show the content of the version of the source fragment that is selected by the special version selection rule at the time. When an author edits the fragment in context, the forking process described above occurs. Special forkable mode can be used, for example, to use an evolving template whose edits are subject to periodic approval as a basis for creating instances of new content.

Special follow mode (1) is not editable in context, and (2) specifies a special version selection rule. Thus, a special follow reference shows the version of the fragment that satisfies the version selection rule at any given time, which is not editable in context. This mode can be used, for example, to pull into a document or fragment centrally-authored content that is periodically rereleased by its authors to reflect all edits occurring since the last release.

A user may at any subsequent time change the mode of the incorporated content via various user interface techniques, such as by right-clicking on the incorporated content and selecting an item from a resulting context menu, selecting incorporated content and choosing a menu-bar menu item, interacting with a specialized control that is displayed when the mouse cursor hovers over the incorporated content, etc. In some embodiments, the facility incorporates or interoperates with a system of authority and access controls and other content governance measures limit the actions that can be taken by a particular user with respect to a particular document or fragment in various circumstances, including changing the mode of an existing fragment reference.

In some embodiments, when retrieving the time-specified fragment version for content incorporated in pinned mode, the facility notifies the user if a version of the origin fragment that is more recent than the read-only fragment to enable the user to switch the mode to live, or remain in pinned mode but replace the time specified for the version in the reference with the time corresponding to the latest version.

In some embodiments, the facility maintains metrics on the incorporation of fragments into documents to be able to report on various “hot fragments” measures, which identify fragments that are incorporated into the most total documents, or fragments that have been incorporated into the most documents during a recent period of time, across an organization or another group of users, among a group or category of documents, etc.

By operating in some or all of the ways described above, the facility enables users to easily and intuitively access valuable, useful information about any document's revision history. Also, by operating in some or all of the ways described above, the facility reduces the amount of storage space needed to store documents and their revisions, and expedites the retrieval and processing of this information. Additionally, the facility enables human users to more quickly and easily specify information they wish to display, and display new kinds of information not formerly possible.

### Hardware

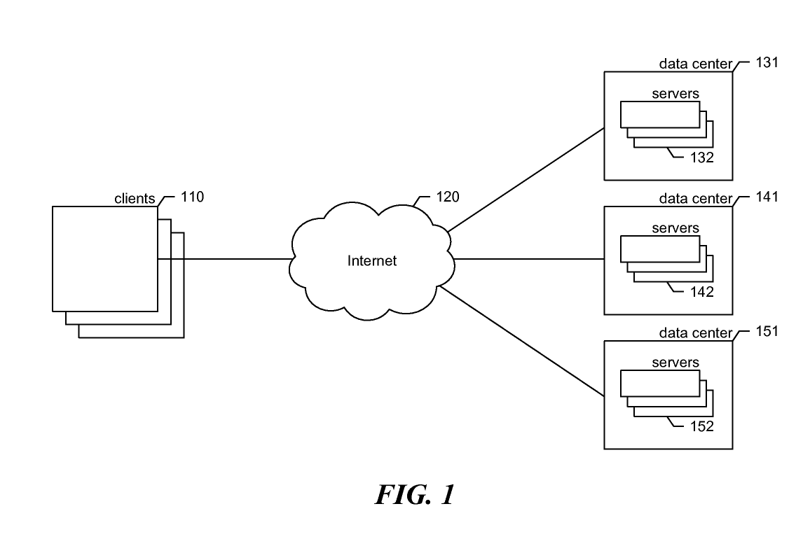

FIG. 1 is a network diagram showing the environment in which the facility operates in some embodiments. The network diagram shows clients 110 each being used by a different user. Each of the clients executes software enabling its user to create, revise, and present electronic documents. Software on the client also enables the client to retrieve and synthesize remotely-stored document contents, including document fragments. In particular, the Internet 120 or one or more other networks connect each of the clients to a number of different data centers, e.g., data centers 131, 141, and 151, which in some embodiments are distributed geographically to provide disaster and outage survivability, both in terms of data integrity and in terms of continuous availability. Distributing the data centers geographically also helps to minimize communications latency with clients in various geographic locations. Each of the data centers contain servers, e.g. servers 132, 142, and 152. The servers access storage devices containing document contents, including document fragments, and execute software for responding to requests from clients and other servers to store and retrieve document contents, again including document fragments. In various embodiments, the facility uses various different distributions of responsibility for retrieving and combining document fragments between the clients and the servers.

While various embodiments are described in terms of the environment described above, those skilled in the art will appreciate that the facility may be implemented in a variety of other environments including a single, monolithic computer system, as well as various other combinations of computer systems or similar devices connected in various ways. In various embodiments, a variety of computing systems or other different devices may be used as clients, including desktop computer systems, laptop computer systems, automobile computer systems, tablet computer systems, smart phones, personal digital assistants, televisions, cameras, etc.

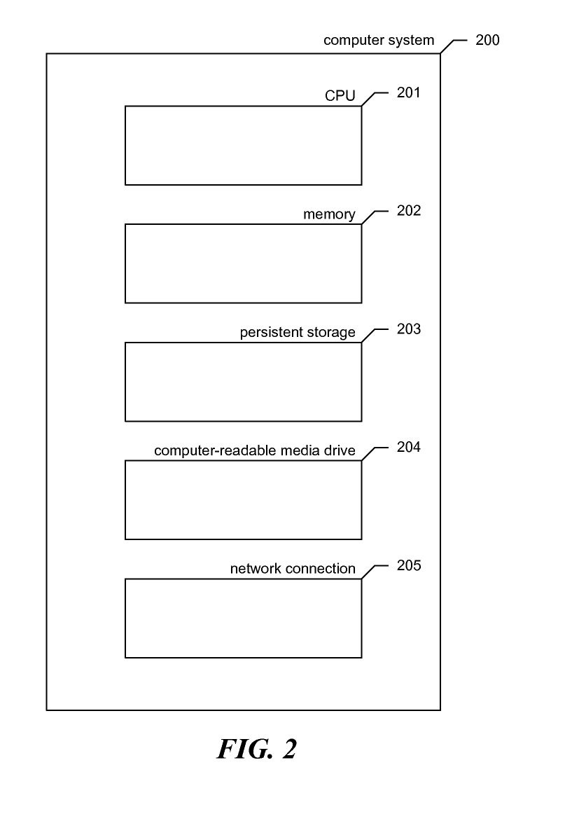

FIG. 2 is a block diagram showing some of the components typically incorporated in at least some of the computer systems and other devices on which the facility operates. In various embodiments, these computer systems and other devices 200 can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (“CPU”) 201 for executing computer programs; a computer memory 202 for storing programs and data while they are being used, including the facility and associated data, an operating system including a kernel, and device drivers; a persistent storage device 203, such as a hard drive or flash drive for persistently storing programs and data; a computer-readable media drive 204, such as a floppy, CD-ROM, or DVD drive, for reading programs and data stored on a computer-readable medium; and a network connection 205 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

### Fragment Management

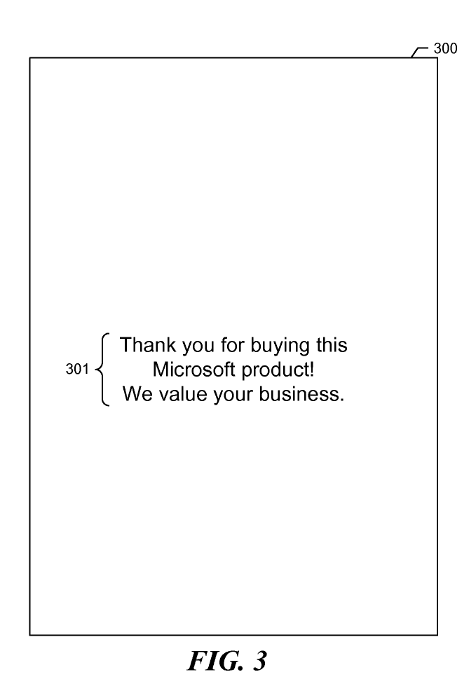

FIGS. 3-5 are display diagrams showing the editing and display of a document incorporating a shared document fragment. FIG. 3 is a display diagram showing a sample target document at a time before the shared document fragment is incorporated. The target document 300 includes text 301. This text may be directly contained by the root fragment for the target document, or may be contained by a fragment identified by a fragment reference within the root fragment for the target document.

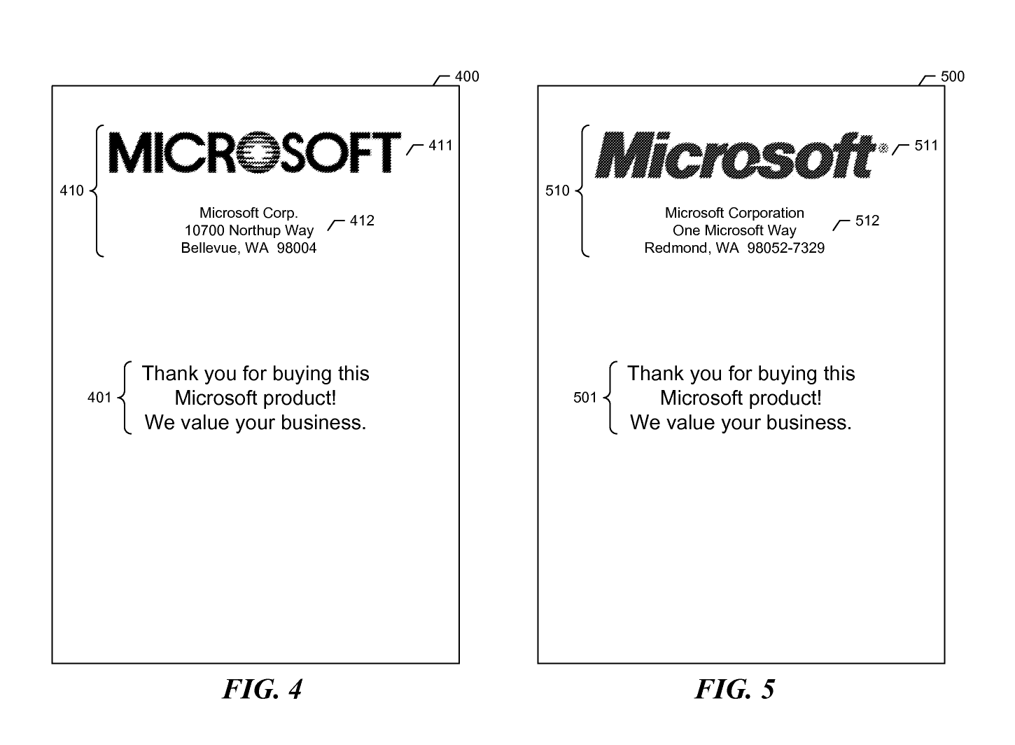

FIG. 4 is a display diagram showing the sample target document at a time immediately after the shared document fragment is incorporated. At this time, the target document 400, in addition to containing text 401, contains incorporated content 410 transferred from a source document (not shown). The incorporated content constitutes a company's letterhead, including both an image 411 of the company's logo and the company's textual address 412.

Where the user incorporates the letterhead content in pinned mode, the letterhead content will remain unchanged in the target document unless and until the incorporation is changed to a different mode. Where the user incorporates the letterhead content in forked mode, the user can change the letterhead content in the context of the target document; such changes will not affect the letterhead content in the source document, and any changes to letterhead content in the source document will not be reflected in the target document. Where the user incorporates the letterhead content in live mode, the user can, subject to any applicable permissions, change the letterhead content in the context of the target document, and doing so will change the letterhead content in the source document and any other document that incorporates the letterhead content in live mode. Similarly, changes to the letterhead content via the source document or any other document that incorporates the letterhead content in live mode will be reflected in the target document.

FIG. 5 is a display diagram showing the sample target document where, after the shared document fragment is incorporated into the target document in live mode, the content is changed in the context of the source document, such as by another user. It can be seen that, in the target document 500 at this time, the letterhead content 510 contains a new company logo 511 and a new company address 512, both substituted in the context of the source document, and reflected in the target document pursuant to the target document's incorporation of this content in live mode.

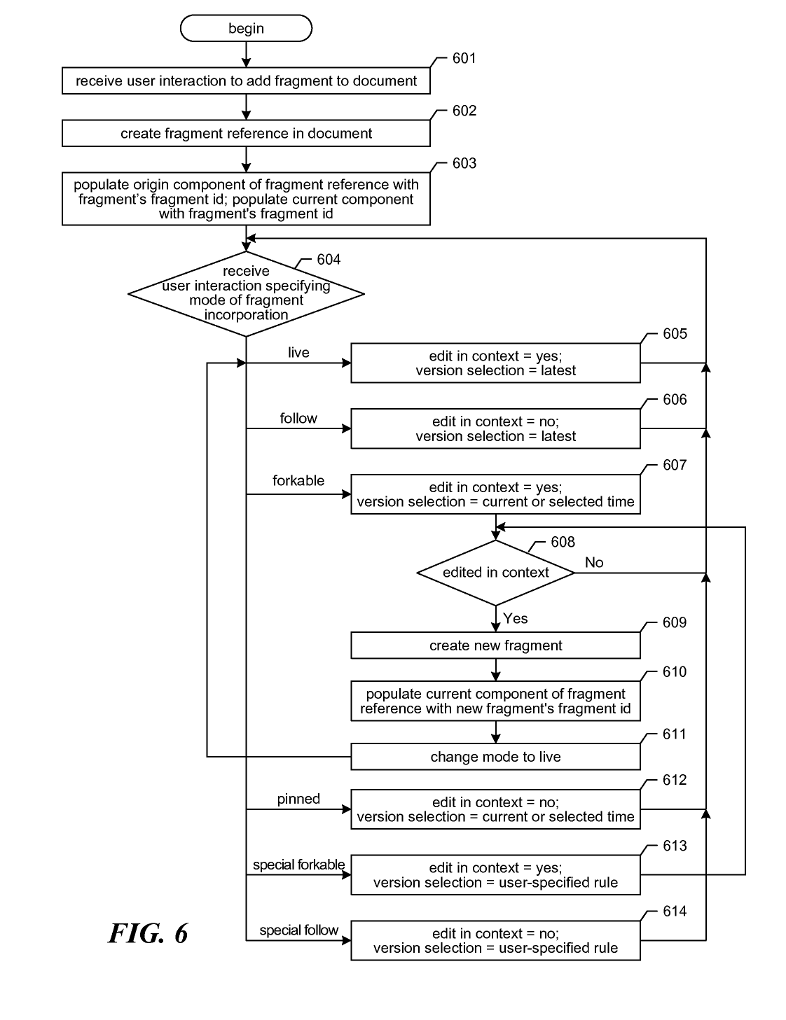

FIG. 6 is a flow diagram showing steps typically performed by the facility in some embodiments in order to incorporate a document fragment into a document, and adjust the mode of its incorporation. In step 601, the facility receives a user interaction to add a fragment to a target document. In various embodiments, such interactions can be, for example, copying the selected content onto the clipboard, then pasting it into the target document at the target position; dragging the selected content from the source document to the target position in the target document; etc. Where the user selects content to add to the target document that don't exactly correspond to whole existing fragments, the facility creates one or more fragments to which the selected content does exactly correspond, such as by subdividing fragments that occur in the source document. In some cases, this involves altering and/or adding fragment references in the source document, and in one or more other documents incorporating the same content in live mode.

In step 602, the facility creates a fragment reference in the target document. In step 603, the facility populates both the origin component of the fragment reference and its current component with the fragment ID of the fragment added to the document. In step 604, the facility receives a user interaction specifying a mode for incorporating the fragment in the target document. In some embodiments, a single interaction or a related sequence of interactions can both add the fragment to the document and specify a mode. If the user action received in step 604 specifies the live mode, then the facility continues in step 605; if it specifies the follow mode, then the facility continues in step 606; if it specifies the forkable mode, then the facility continues in step 607; if it specifies the pinned mode, then the facility continues in step 612; if it specifies the special forkable mode, then the facility continues in step 613; and if it specifies the special follow mode, then the facility continues in step 614.

In step 605, where the live mode is specified, the facility sets edit in context to yes for the reference, and sets version selection to latest. After step 605, the facility continues in step 604 to permit the user to, at a later time, specify a new mode for this fragment. In step 606, where the follow mode is specified, the facility sets edit in context to no for the reference, and sets version selection to latest. After step 606, the facility continues in step 604. In step 607, where the forkable mode is specified, the facility sets edit in context to yes for the reference, and sets version selection to the current time, or an earlier time selected by the user. In step 608, if the user chooses to edit the fragment in the context of the reference, then the facility continues in step 609, else the facility continues in step 604. In step 609, the faculty creates a new fragment that reflects application of the edit of step 608 to the added fragment. The new fragment has a different fragment ID than the added fragment. In step 610, the facility populates the current component of the fragment reference with the new fragment's fragment ID. In step 611, the facility changes the reference's mode to live. After step 611, the facility continues in step 605. In step 612, where the pinned mode is specified, the facility sets edit in context to no for the reference, and sets version selection to the current time, or to an earlier time selected by the user. After step 612, the facility continues in step 604. In step 613, where the special forkable mode is specified, the facility sets edit in context to yes, and sets version selection to a version selection rule, such as a version selection rule specified via additional user interactions, a default version selection rule, an inferred version selection rule, etc. After step 613, the facility continues in step 608. In step 614, where the special follow mode is specified, the facility sets edit in context to no, and sets version selection to a version selection rule in a manner similar to step 613. After step 614, the facility continues in step 604.

Those skilled in the art will appreciate that the steps shown in FIG. 6 and in each of the flow diagrams discussed below may be altered in a variety of ways. For example, the order of the steps may be rearranged; some steps may be performed in parallel; shown steps may be omitted, or other steps may be included; a shown step may be divided into sub steps, or multiple shown steps may be combined into a single step, etc.

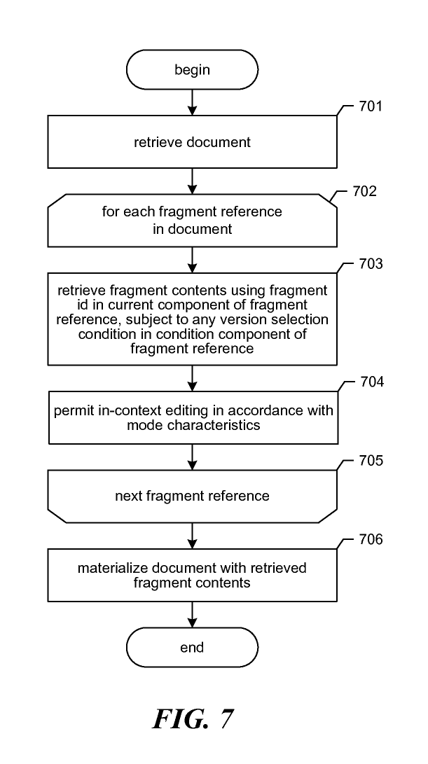

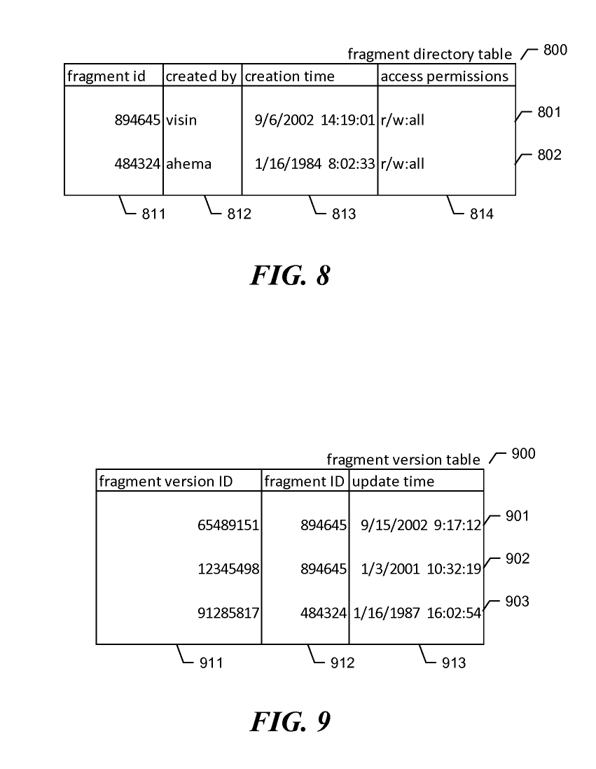

FIG. 7 is a flow diagram showing steps typically performed by the facility in some embodiments in order to materialize a document containing shared fragments. In various embodiments, the facility performs these steps when a document is opened, when a document needs to be displayed, when a user attempts to add it to document, etc. In various embodiments, the facility's performance of these steps is distributed between the client and servers in various ways. In step 701, the facility retrieves a document, such as by retrieving its root fragment. The facility loops through steps 702-704 for each fragment reference occurring in the document, including transitive fragment references from one fragment to another. In step 703, the facility retrieves content of the fragment using the fragment ID contained in the current component of the fragment reference. This retrieval is subject to any version selection condition contained in the condition component of the fragment reference; that is, the retrieval is performed with respect to the latest version of the fragment that specifies any contained version selection condition, or, absent a version selection condition, the latest version of the fragment. In various embodiments, the facility uses various forms of fragment version selection logic. In some embodiments, the process of retrieving a fragment indicates permissions associated with the fragment, including whether the fragment can be edited by the current user, which the facility uses to indicate and control whether the user can edit the fragment in the context of the document. Fragment retrieval is discussed in greater detail below in connection with FIGS. 8-11. In step 704, the facility makes the fragment editable in context based on the mode of the fragment reference. In step 705, if additional fragment references remain to be processed, then the facility continues in step 702 to process the next fragment reference, else the facility continues in step 706. In step 706, the facility materializes the document using the fragment contents retrieved in step 703. After step 706, these steps conclude. In some embodiments (not shown), rather than performing the processing shown in FIG. 7 in a loop, the facility performs it as a recursive descent of a tree-like graph with lenses acting as parents of content nodes, and modifying rendering behavior as the document is materialized.

FIG. 8 is a table diagram showing sample contents of a fragment directory table used by the facility in some embodiments to store information about fragments. In some embodiments, the fragment directory table, and the other tables described in FIGS. 9-11, are stored in a data center on a storage device accessible to servers executing server software that is part of the facility. In some embodiments, some or all of these tables are stored in multiple data centers in order to provide survivability and a measure of locality for the data they store. The fragment directory table 800 is made up of rows such as rows 801-802 each corresponding to a different fragment. Each row is divided into the following columns: a fragment ID column 811 containing a fragment ID identifying the fragment to which the row corresponds; a created by column 812 containing information identifying a user that created the fragment; a creation time column 813 having contents indicating the time at which the fragment was created; and an access permissions column 814 specifying the ways in which the fragment can be accessed by various users. For example, row 801 indicates that a fragment having fragment ID 894645 was created by user visin at 9/6/2002 14:19:01, and can be read and written by all users. In some embodiments, the facility employs geographically-invariant times, such as times expressed in Greenwich Mean Time, in order to coordinate servers and clients located in different time zones. Where the server receives a retrieval request for fragment ID 894645, it uses row 801 to determine access permissions for this fragment.

While FIG. 8 and each of the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed, encrypted, and/or indexed; may contain a much larger number of rows than shown, etc.

FIG. 9 is a table diagram showing sample contents of a fragment version table used by the facility in some embodiments to store information about fragment versions. In particular, the facility uses the fragment version table to identify the different versions of a fragment that exist, and their time order. In some embodiments, the facility maintains only a single version of each fragment, in which case the fragment version table is not necessary, and fragment IDs are substituted for fragment version IDs in other tables maintained by the facility. The fragment version table 900 is made up of rows such as rows 901-903 each corresponding to a different fragment version. Each of the rows is divided into the following columns: a fragment version ID column 911 containing a fragment version ID for the fragment version to which the row corresponds that uniquely identifies this fragment version; a fragment ID column 912 containing the fragment ID identifying the fragment to which this fragment version corresponds; and an update time column indicating the time at which the fragment version was last updated. For example, row 901 indicates that the fragment version having fragment version ID 65489151 corresponds to the fragment having fragment ID 894645, and was last updated at 9/15/2002 9:17:12. Where the server receives a retrieval request for fragment ID 894645, it uses rows 901 and 902 to identify the two fragment versions that exist for this fragment ID. These two rows can also be used to determine which of the fragment versions is more recent.

In some embodiments, where fragment versions are used, some fragment versions are writeable, such that an author can change the content at a time after it is created, at least in the case of fragment versions that are not referenced by any pinned fragment references. However, in some embodiments, every fragment version is read-only, and any revision of content contained by an existing fragment version causes the facility to create a new fragment version. In various embodiments, the creation of a new fragment version occurs at various levels of granularity, including a new fragment version for each editing session, a new fragment version for each keystroke, or at some level in between, such as every five seconds, every minute, every 15 minutes, etc.

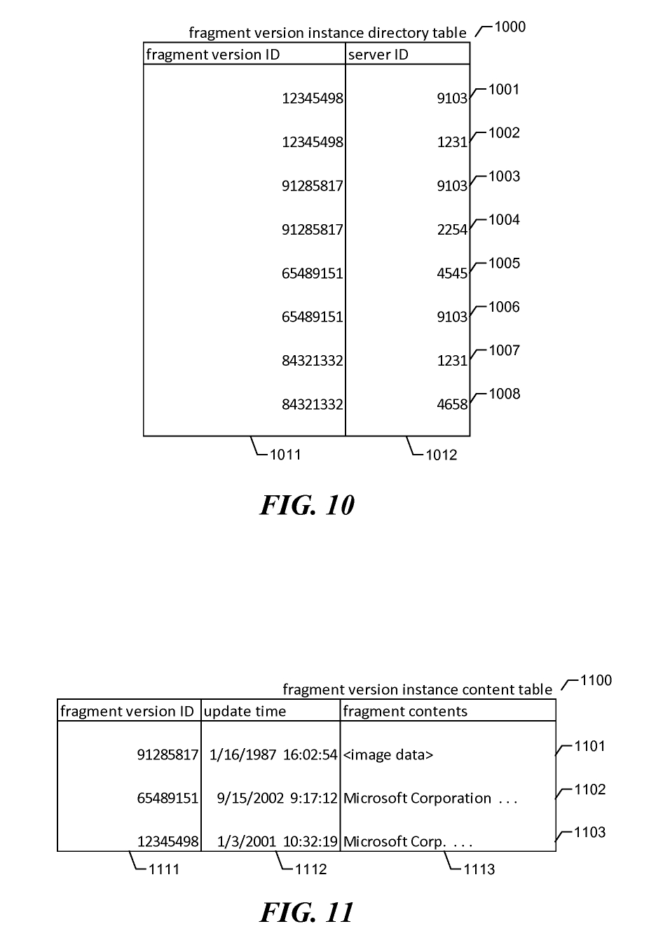

FIG. 10 is a table diagram showing sample contents of a fragment version instance table used by the facility in some embodiments to store information about fragment version instances. In particular, the facility uses the fragment version instance directory table to identify, for particular fragment version, instances of the fragment version that are stored on different servers, so that the facility can choose one of the fragment versions for retrieval, and so that, if a fragment version is being changed in an embodiment where this is possible, every instance of it can be changed or invalidated. The fragment version instance directory table 1000 is made up of rows such as rows 1001-1008 each corresponding to a different combination of a fragment version and a server on which an instance of the fragment version is stored. Each row is divided into the following columns: a fragment version ID column 1011 containing if fragment version ID identifying the fragment version; and a server ID column 1012 identifying a server on which an instance of the fragment version is stored. For example, row 1001 indicates that the fragment version having fragment version ID 12345498 has an instance stored on the server having server ID 9103. In various embodiments, the facility uses various other approaches to identifying locations in which instances of fragment versions are stored, such as by using data center IDs, storage device IDs, etc.

FIG. 11 is a table diagram showing sample contents of a fragment version instance content table used by the facility in some embodiments to store fragment version instance content. The fragment version instance content table 1100 is made up of rows such as rows 1101-1103 each corresponding to fragment version instances all stored on a particular server. The fragment version instance content table 1100 is, in particular, stored on the server having server ID 9103. Each of the rows is divided into the following columns: a fragment version ID column 1111 containing the fragment version ID identifying the fragment version to which the row corresponds; an update time column 1112 indicating the time at which the fragment version instance was last updated; and a fragment contents column 1113 containing the contents of the fragment version instance. For example, row 1101 indicates that the fragment version instance having fragment version ID 91285817 and update time 1/16/1987 16:02:54 contains particular image data. It is the fragment 1113 that contains the data that the facility returns in response to a fragment retrieval request.

In some embodiments, rather than storing each fragment version instance as a single entity as shown in FIG. 11, the facility employs an “erasure coding” technique in which it distributes the contents of each fragment version instance as any number of smaller shreds, which can be stored on any arrangement of servers.

### History Visualization

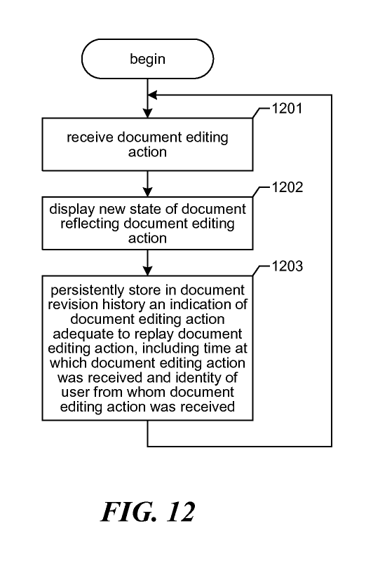

FIGS. 12-14 illustrate embodiments in which the facility maintains a centralized document revision history to track revisions to a document.

FIG. 12 is a flow diagram showing steps typically performed by the facility in some embodiments to record a document revision history for a document being edited. In step 1201, the facility receives a document editing action from a user with respect to the document. Document editing actions include all operations that change the state of the document, such as deleting the content at a range of positions within the document, inserting a character at a position in the document, changing formatting attributes within the document, incorporating a fragment in the document or deleting a fragment earlier incorporated in the document, etc. In step 1202, the facility displays the new state of the document so that the author can see how the state of the document is affected by the document editing action received in step 1201. In step 1203, the facility persistently stores in a document revision history for the document an indication of the document editing action that is adequate to replay the document editing action transforming the state of the document before the document editing action was received to the state of the document after the document editing action was received and applied. This action indication includes the time at which the document editing action was received, and the identity of the user from whom the document editing action was received. After step 1203, the facility continues in step 1201 to receive the next document editing action. In some embodiments, the facility performs the steps of FIG. 12 concurrently for multiple users all submitting document editing actions for the same document during the same period of time.

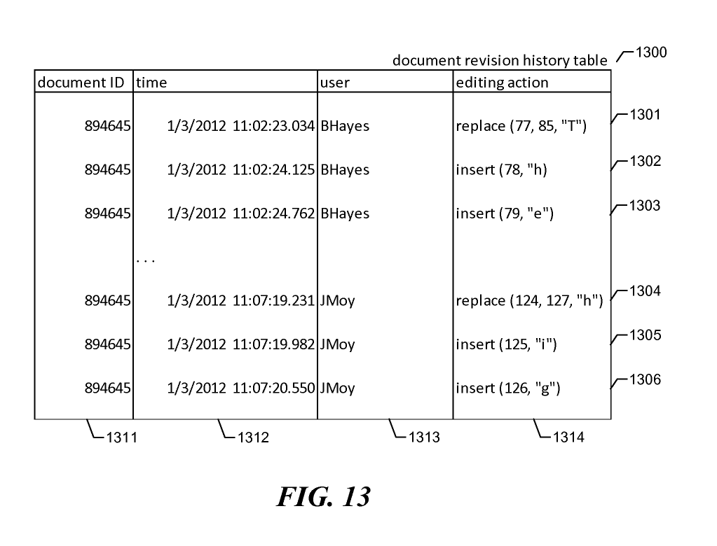

FIG. 13 is a table diagram showing sample contents of a document revision history table used by the facility in some embodiments to store document revision histories for one or more documents. The document revision history table 1300 is made up of rows, such as rows 1301-1306, each corresponding to a different document editing action received from a user by the facility. Each row is divided into the following columns: a document ID column 1311 containing an identifier identifying the document for which the document editing action was received; a time column 1312 containing the time at which the document editing action was received; a user column 1313 containing information identifying a user who submitted the document editing action; and an editing action column 1314 containing the particular editing action performed. For example, row 1301 indicates that at 11:02:23.034 on 1/3/2012, a document editing action was performed by user BHayes for the document having document ID 894645 to replace the characters in position range 77-85 with the letter “T.” The overall effect of the editing actions represented by rows 1301-1303 is to replace the characters in position range 77-85 with the word “The.” Rows 1304-1306 show that, a few minutes later, the user JMoy replaced the characters in position range 124-127 with the string “hig.” In various embodiments, the facility operates in connection with documents of various types, each of which has its own set of editing action types. For example, editing actions in a spreadsheet document can include inserting or deleting columns, changing the formula in a cell, altering conditional cell background shading rules, etc. Changes to a slide show document can include inserting or deleting a slide, adding an animation between slides, inserting an audio clip into a slide, etc.

In some embodiments (not shown), the facility stores revision histories on a per-fragment basis. In these embodiments, the facility uses a document's fragment graph at a particular point in time to identify the fragments making up the document at that point in time, and collects editing actions from the revision histories of all of those fragments. In certain embodiments (not shown), aspects of the facility's user interface and/or analytics relate to individual fragments, as contrasted with entire documents that may contain many fragments.

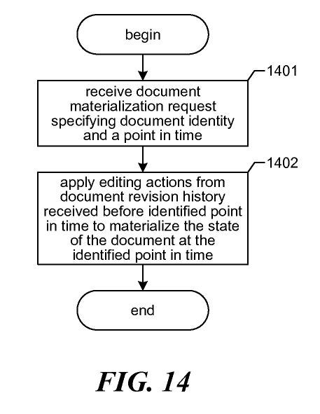

FIG. 14 is a flow diagram showing steps typically performed by the facility in some embodiments in order to materialize a document at an arbitrary point in time after its creation using a document revision history. In step 1401, the facility receives a document materialization request specifying the identity of a document and a point in time. As one example, the facility receives a document materialization request specifying the document ID 894645, and the point in time 11:07:19.445 on 1/3/2012. In step 1402, the facility applies the editing actions from the document revision history that were received before the identified point in time in order to materialize the state of the document at the identified point in time. To continue the example, the facility applies all of the editing actions shown in FIG. 13 up through the editing action to which row 1304 corresponds, to the exclusion of the editing actions to which rows 1305 and later correspond. In some embodiments, the facility applies the editing actions beginning at the document creation time against an empty document. In some embodiments, the facility retrieves a version of the document representing its state at a point in time earlier than the point in time identified in the document materialization request, and applies to this version all of the editing actions that occurred at a time later than the retrieved version of the document represents and earlier than the point in time identified by the document materialization request. After step 1402, these steps conclude.

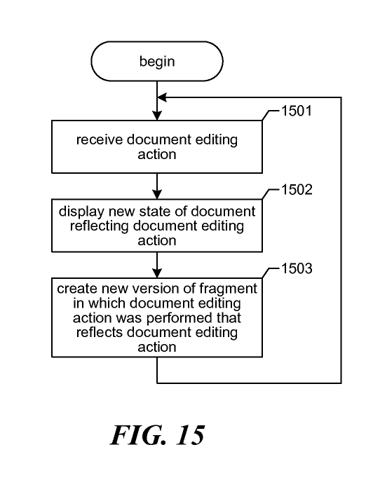

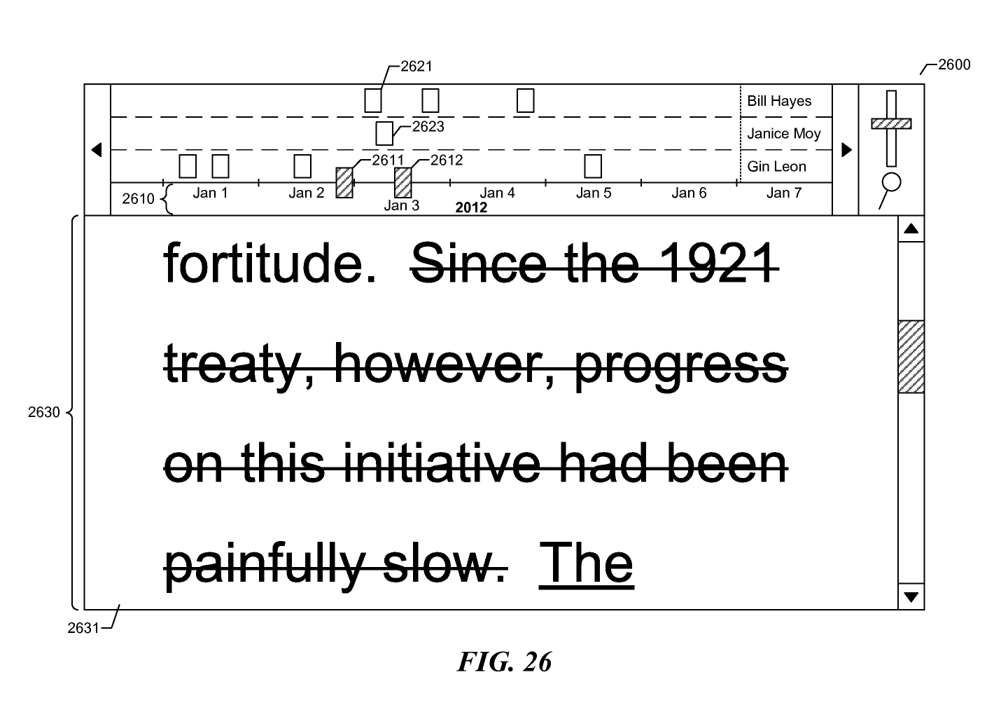

FIGS. 15-17 illustrate embodiments in which the facility creates a new fragment version for each editing action performed by an author. In some such embodiments, the facility omits to maintain a centralized document revision history as described above in connection with FIGS. 12 and 13. In some such embodiments, however, the facility does maintain such a document history, such as for the purpose of efficiently generating certain document revision visualizations such as the one shown in FIG. 26 and described below in conjunction therewith.

FIG. 15 is a flow diagram showing steps typically performed by the facility in some embodiments to create a new document fragment for each editing action performed on a document. Steps 1501 and 1502 are similar to steps 1201 and 1202 in FIG. 12 described above. In step 1503, the facility creates a new version of the fragment in which the document editing action received in step 1201 was performed; the new version of that fragment created by the facility reflects the document editing action—that is, the new version of the fragment that is created is one that results from application of the document editing action to the previous version of the fragment. The facility stores in, with, or for this new fragment the time at which the document editing action was received, and the identity of the user, or “author,” from whom the document editing action was received. After step 1503, the facility continues in step 1501 to receive the next document editing action. As with the steps in FIG. 12, in some embodiments, the facility performs the steps of FIG. 15 concurrently for multiple users all submitting document editing actions for the same document during the same period of time.

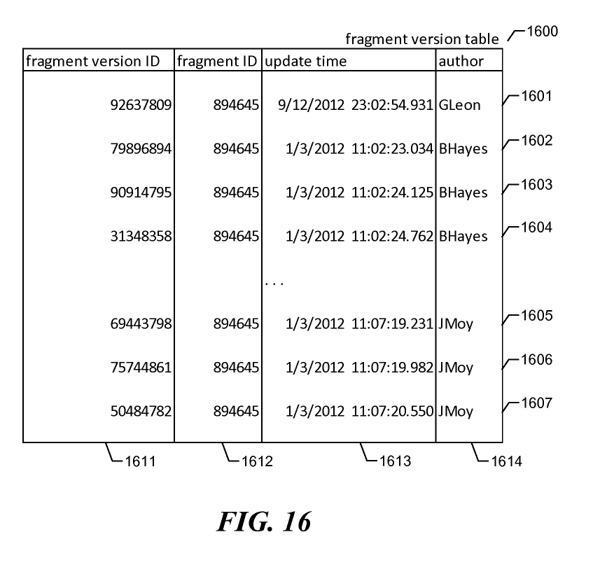

FIG. 16 is a table diagram showing sample contents of a fragment version table reflecting creation by the facility in some embodiments of a new document fragment version for each editing action performed with respect to the fragment or other document. The fragment version table 1600 is made up of rows, such as rows 1601-1607, each corresponding to a different fragment version. While FIG. 9 discussed above shows that a fragment version table can contain versions of multiple different fragments, it can be seen that rows 1601-1607 shown here each correspond to a different fragment version for the same fragment, the fragment having fragment ID 894645. In particular, the fragment versions to which these rows correspond are fragment versions each reflecting one of the editing actions represented in the document version history table shown in FIG. 13. For example, row 1602 indicates that a version of the fragment having fragment ID 894645, which has a fragment version ID of 79896894, reflects an editing action performed by author BHayes at 11:02:23.034 on 1/3/2012. Thus, the fragment to which row 1602 in the fragment version table corresponds represents the same editing action as row 1301 of the document revision history table shown in FIG. 13.

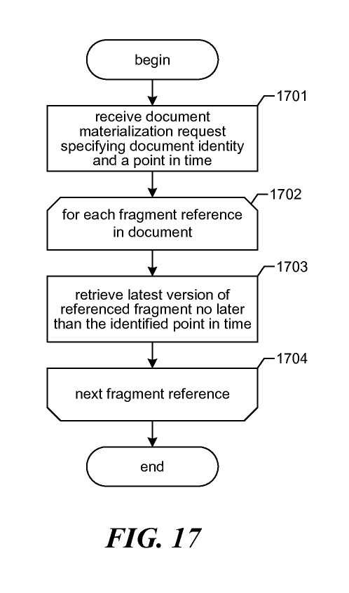

FIG. 17 is a flow diagram showing steps typically performed by the facility in some embodiments in order to materialize a document at an arbitrary point in time after its maintenance using per-editing action fragment versions. Step 1701 is similar to step 1401 described above. In steps 1702-1704, the facility loops through each fragment reference in the document. As noted above, a fragment reference may be included in a document by virtue of being present in the document's root fragment, being present in a fragment referred to by a fragment reference in the root fragment, and so on. Accordingly, in step 1702, the facility initializes a set of fragment references to include a fragment reference to the root, and begins the loop with that fragment reference. In step 1703, the facility retrieves a version of the fragment referenced in the fragment reference that is the latest version of that fragment that is not later than the identified point in time received in step 1701. As part of this retrieval, the facility adds any fragment references contained by the retrieved fragment version to the set of fragment references to be processed in the loop. In step 1704, if the set of fragment references to be processed is not empty, the facility continues in step 1702 to process the next fragment reference, else these steps conclude, having materialized the document. In some embodiments (not shown), rather than performing the processing shown in FIG. 17 in a loop, the facility performs it as a recursive descent of a tree-like graph of fragment nodes.

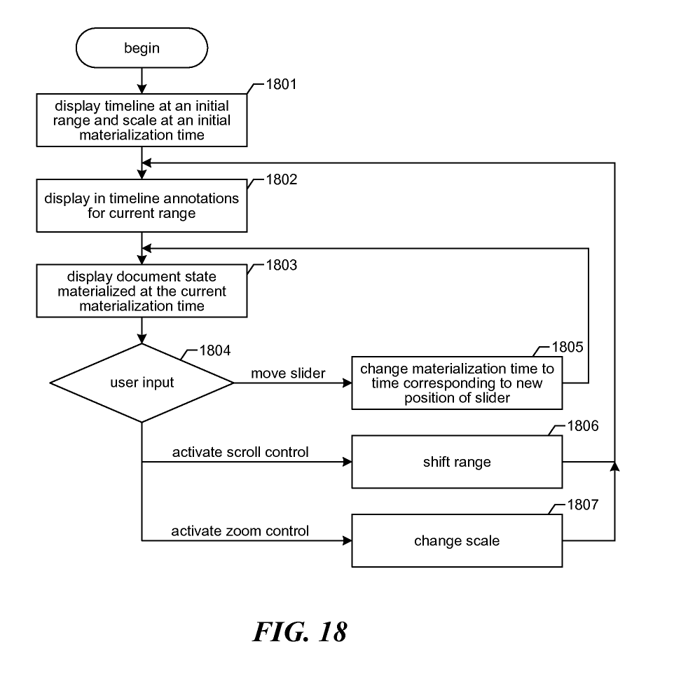

FIG. 18 is a flow diagram showing steps typically performed by the facility in some embodiments in order to display a varying state of a document in response to user interactions with a timeline user interface control. In step 1801, the facility displays a timeline having an initial time range and scale and an initial materialization time. In some embodiments, the initial range is the period between creation of the document and the present, and the initial scale is a scale at which this range substantially occupies the space for the timeline. In some embodiments, the facility displays the timeline by linking a materialized view of the timeline—represented as one or more fragments—with a materialized view of the document, also composed of one or more fragments.

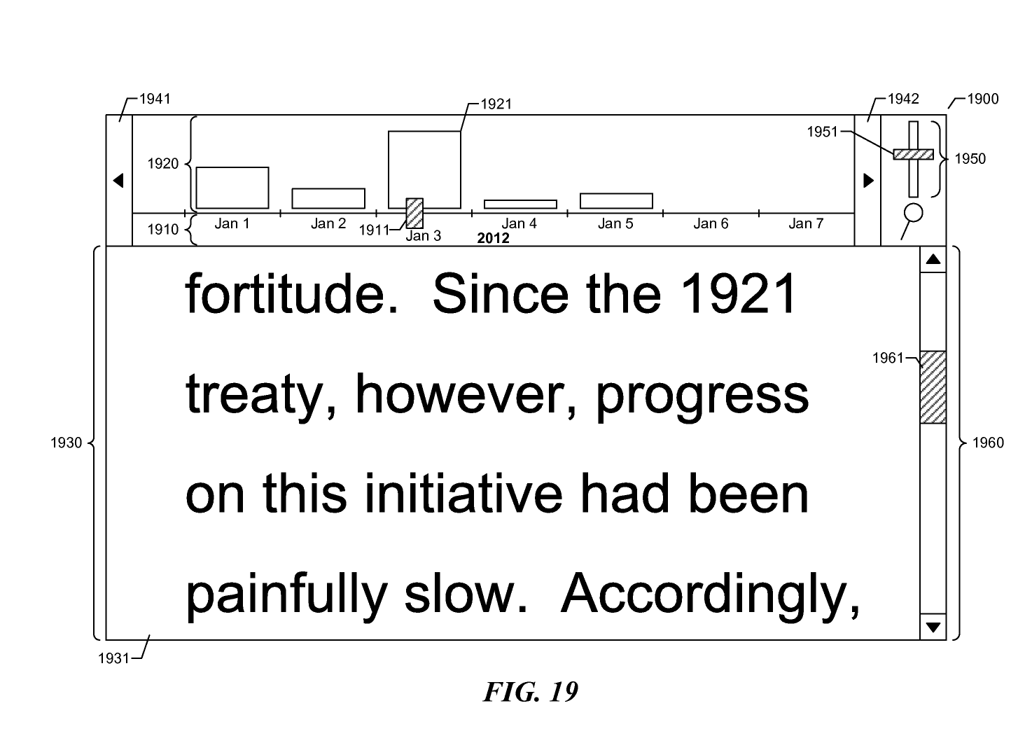

FIG. 19 is a display diagram showing a sample display presented by the facility in some embodiments in which the timeline is in an initial state. The display 1900 includes a timeline 1910 covering the range Jan. 1-Jan. 7, 2012. A slider 1911 is positioned within the day Jan. 3, 2013 on the timeline so that the document displayed below will be materialized at that point in time. The display also includes scroll controls 1941 and 1942, which the user can activate to shift the time range displayed in the timeline earlier or later, respectively. The display also includes zoom control 1950/1951, which the user can manipulate to change the zoom level of the timeline.

Returning to FIG. 18, in step 1802, the facility displays in the timeline annotations for the current range of times.

Returning to FIG. 19, it can be seen that a number of editing volume annotations 1920 are displayed, indicating the relative volume of editing actions taken on each of the displayed days. For example, volume annotation 1921 shows that the greatest volume of editing annotations during the shown period was performed on the day Jan. 3, 2012.

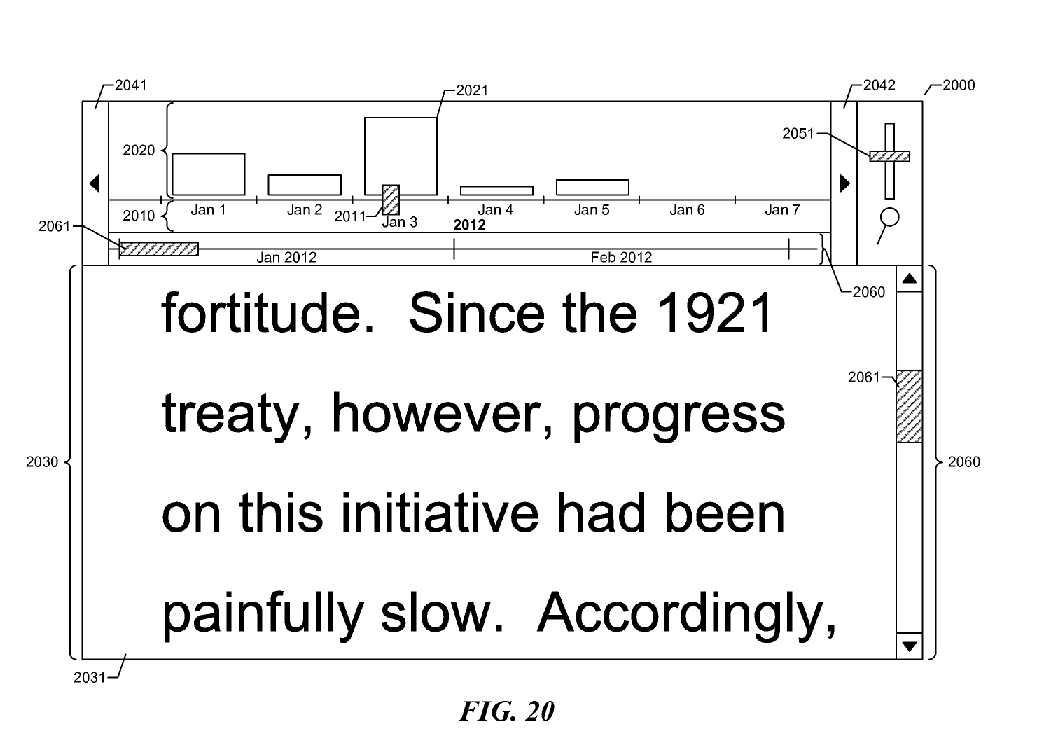

FIG. 20 is a display diagram showing a sample display presented by the facility in some embodiments in which the timeline in an initial state is displayed in an alternate form. In particular, the display 2000 further contains a document lifetime timeline 2060. The period of time represented by the document lifetime timeline is the entire lifetime of the document, beginning with the document's creation, and ending with a time such as when the last editing action was performed on the document, or the present time. Here, it can be seen that the document lifetime represented by the document lifetime timeline is approximately Dec. 26, 2011-Mar. 7, 2012. On the document lifetime timeline, the facility displays an indicator 2061 of the period currently selected for display of the primary timeline 2010 and associated annotations 2020. Here, it can be seen that the indicator 2061 corresponds on the document lifetime timeline to the period Jan. 1, 2012-Jan. 7, 2012 represented by the primary timeline 2010. Changes to the selected period are reflected in the size and position of indicator 2061. For example, scrolling the selected period later will shift the indicator to the right; scrolling the selected period earlier will shift the indication to the left; zooming the selected period in will make the indication narrower; and zooming the selected period out will make the indication wider. Similarly, in some embodiments, the user can adjust the selected period by manipulating indicator 2061. For example, in some embodiments, the user can drag a point near the center of the indicator left or right to scroll the selected period earlier or later, and may drag a point near an end of the indication toward or away from the center of the indication in order to make the selected period shorter or longer. In some embodiments (not shown), the facility displays an abbreviated version of the annotations in connection with the document lifetime timeline.

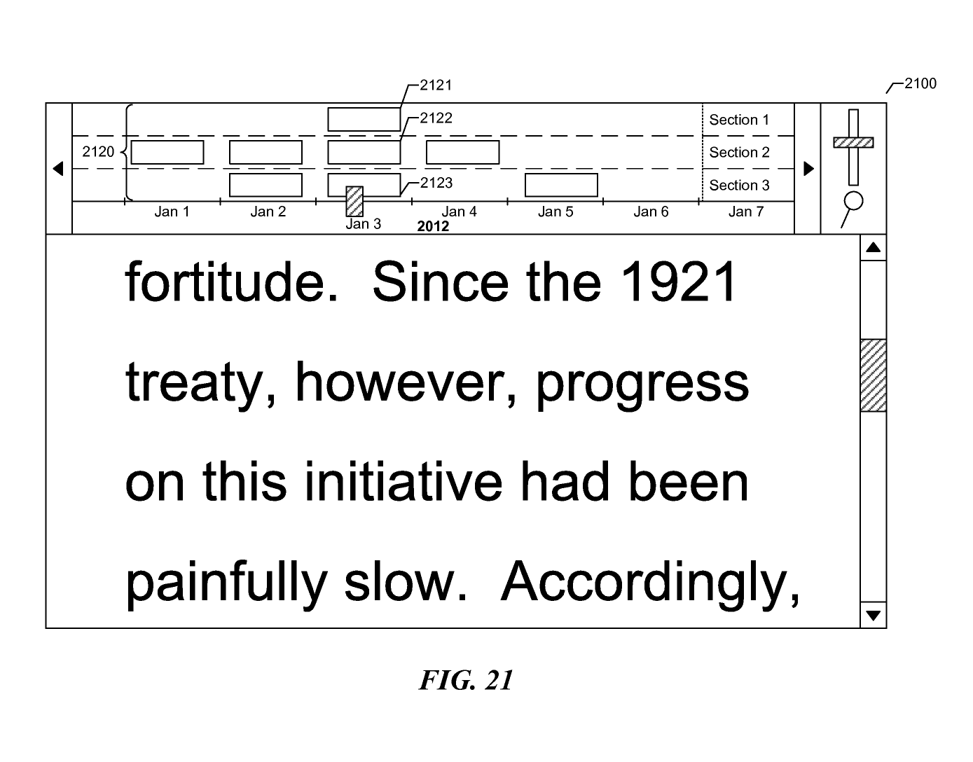

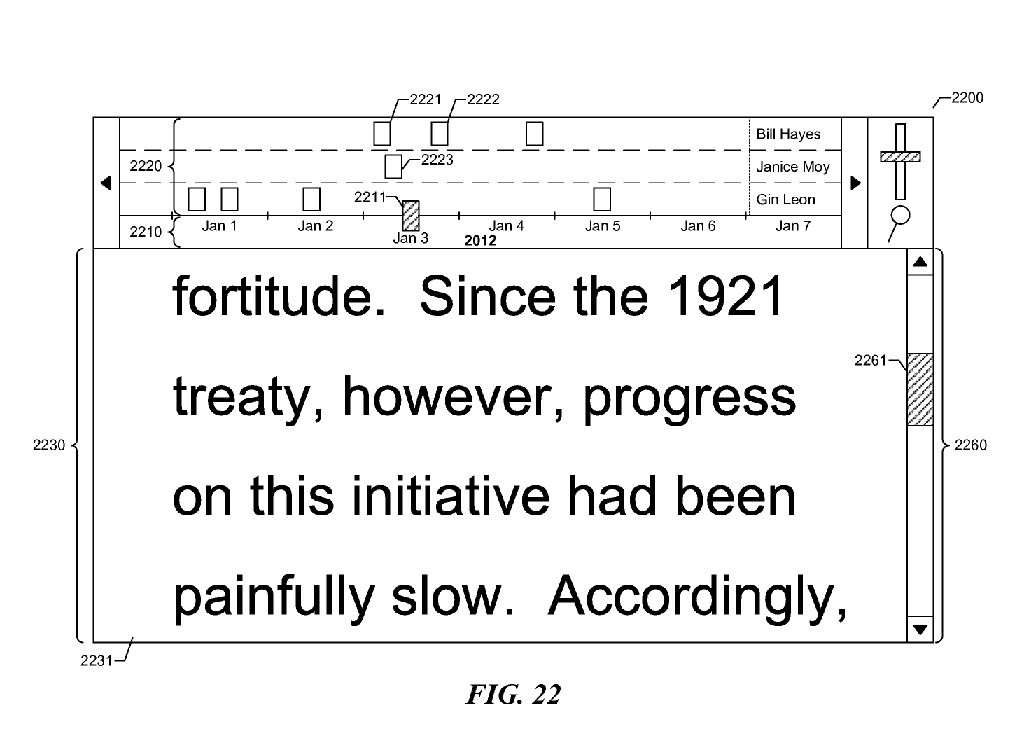

FIGS. 21 and 22 show additional kinds of annotations displayed by the facility in various embodiments.

FIG. 21 is a display diagram showing a sample display presented by the facility in some embodiments in which the timeline is in an initial state having annotations showing which section of the document were edited on which days. A section of the document may comprise one or more fragments or fragment portions; one or more pages, paragraphs, sentences, characters, or heading-delimited document portions; one or more images; one or more sheets, tables, columns, rows, or cells; one or more slides; etc. For example, among the section annotations 2120, section annotations 2121-2123 indicate that all of sections 1, 2, and 3 were edited on Jan. 3, 2012. In some embodiments, each of the section annotations 2120 is the same width.

In other embodiments, the width of each annotation is widened or narrowed to reflect a volume of edits that occurred during the time period, a length of time during which the edits occurred, etc.

FIG. 22 is a display diagram showing a sample display presented by the facility in some embodiments in which the timeline is in an initial state having annotations showing which authors edited the document at different points in time. It can be seen that the timeline is annotated with author editing annotations 2220. For example, annotations 2221 and 2223 show that authors Bill Hayes and Janice Moy edited the document for periods of time that overlapped on Jan. 3, 2012, and annotation 2222 shows that Bill Hayes again edited the document the same day after author Janice Moy's editing concluded. Like the section annotations, in some embodiments, each of the author editing annotations 2220 is the same width. In other embodiments, the width of each annotation is widened or narrowed to reflect a volume of edits that occurred during the time period, a length of time during which the edits occurred, etc. In some embodiments, each author's editing annotations are shown at a different vertical position within the annotations area of the display. For instance, in the illustrated example, Bill Hayes's annotations are displayed in a topmost “lane,” Janice Moy's annotations are displayed in a next lane, and so on. In other embodiments, each author's editing annotations may be displayed in the same lane, but distinguished from each other by color, symbol, character, etc. The same may be true of the section annotations 2120 illustrated by FIG. 21.

Returning to FIG. 18, in step 1803, the facility displays the documents state materialized at the current materialization time reflected by the position of the slider.

Returning to FIG. 22, it can be seen that slider 2211 is positioned within the day Jan. 3, 2012 on the timeline 2210. As a result, a portion of the document 2231 shown in document window 2230 reflects the state of the document at a time during Jan. 3, 2012 that follows the editing actions by author Janice Moy represented by annotation 2223, and precedes the editing actions by author Bill Hayes represented by annotation 2222.

Returning to FIG. 18, in step 1804, the facility receives and branches on user input received from the user viewing the document; if the user input is to move the slider, then the facility continues in step 1805; if the user input is to activate a scroll control, then the facility continues in step 1806; and if the user input is to activate a zoom control, then the facility continues in step 1807. In step 1805, where the user input has moved the slider, the facility changes the materialization time to the time corresponding to the new position of the slider. After step 1805, the facility continues in step 1803 to display a state of the document rematerialized for the new materialization time.

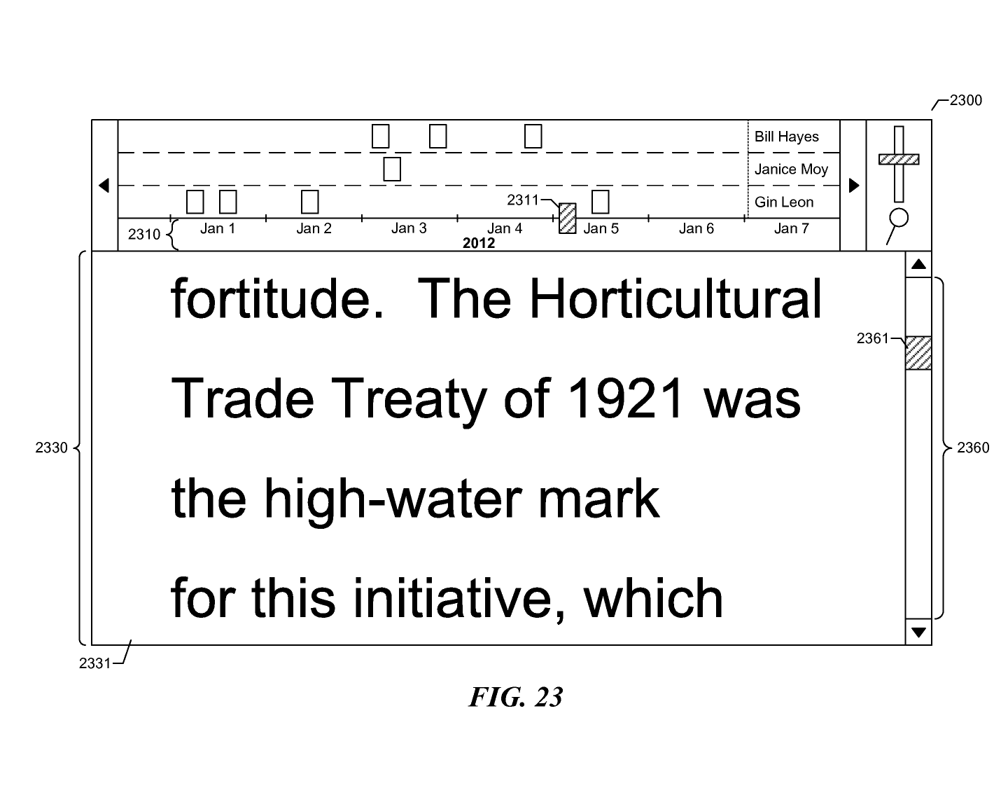

FIG. 23 is a display diagram showing a sample display presented by the facility in some embodiments in which the user has moved the timeline slider. It can be seen that, relative to slider 2211 in timeline 2210 in FIG. 22, in timeline 2310, the user has moved the slider 2311 to a time early on the day Jan. 5, 2012. In response, the facility has updated the state of the document 2331 in document window 2330 from its state 2231 in document window 2230 in FIG. 22 to reflect the state of the document at this new point in time. Also, it can be seen that elevator 2361 in scroll bar 2360 is smaller than the size of the elevator 2261 in scroll bar 2260 in FIG. 22, indicating that the length of the document has increased between Jan. 3, 2012 and Jan. 5, 2012.

Returning to FIG. 18, in step 1806, where the user input activated a scroll control, the facility shifts the range of the timeline. After step 1806, the facility continues in step 1802 to display new annotations for the new range. For example, if the user activates scroll control 2242, the timeline will shift to a later range, whereas if the user activates scroll control 2241, the timeline will shift to an earlier range.

In step 1807, where the user input activates a zoom control, the facility changes the scale of the timeline in accordance with the user's manipulation of the zoom control. After step 1807, the facility continues in step 1802 to redisplay the timeline annotations for the changed scale.

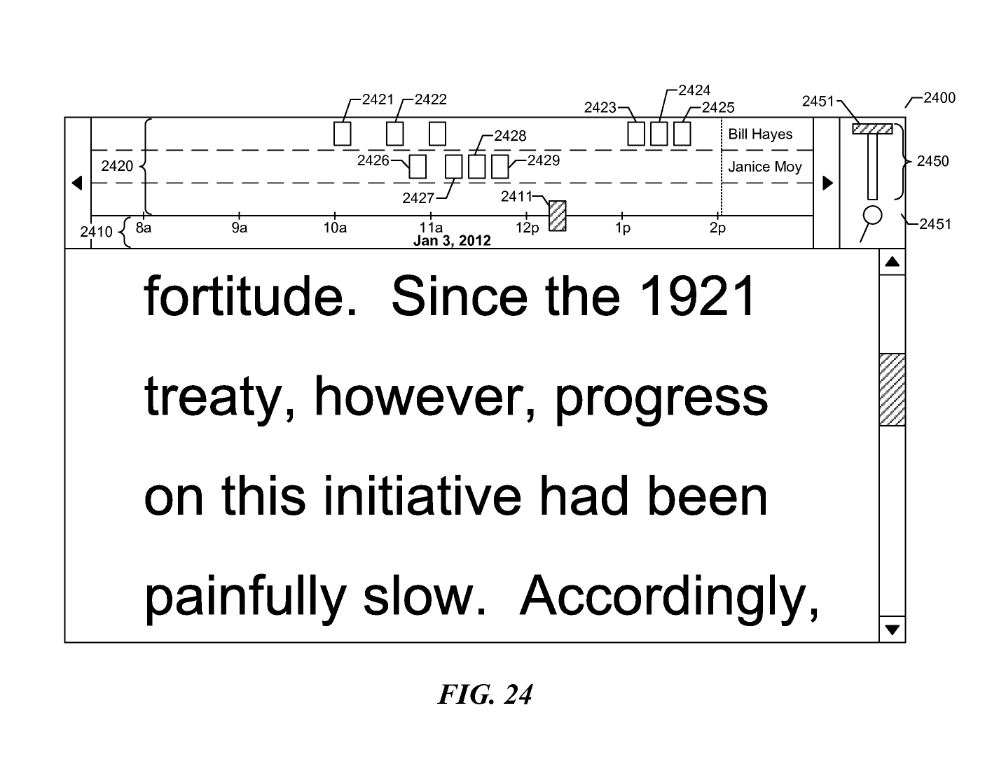

FIG. 24 is a display diagram showing a sample display presented by the facility in some embodiments in which the user has manipulated the zoom control. In particular, relative to zoom control 2251 in FIG. 22, zoom control 2451 in FIG. 24 has been manipulated by the user to zoom further in. As a result, the time scale of timeline 2410 has changed to correspond to a portion of the day Jan. 3, 2012, as compared to the range of days Jan. 1-Jan. 7, 2012 in FIG. 22. It can be seen that, as a result, user editing annotations 2421-2429 occur at a finer time granularity than corresponding annotations 2221-2223 in FIG. 22.

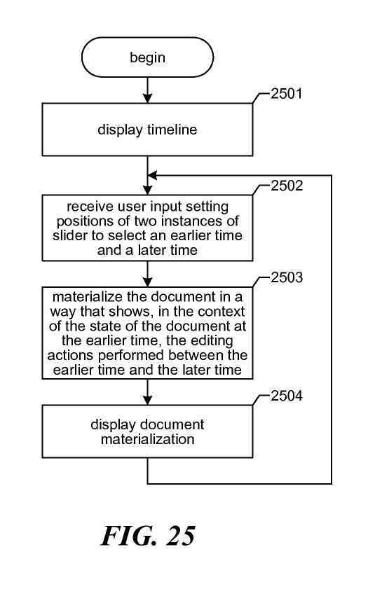

FIG. 25 is a flow diagram showing steps typically performed by the facility in some embodiments in order to enable a user to use the timeline to specify a period of time during which editing actions are to be shown within the document. In step 2501, the facility displays the timeline. In step 2502, the facility receives user input setting the positions of two instances of the timeline slider in order to select both an earlier time and a later time that together bound a period of time.

FIG. 26 is a display diagram showing a sample display presented by the facility in some embodiments in order to enable a user to use the timeline to specify a period of time during which editing actions are to be shown within the document. It can be seen that, on timeline 2610, the user has set the earlier slider instance 2611 to a time near the end of the day on Jan. 2, 2012 and has set the later slider instance 2612 to a time near the middle of the day on Jan. 3, 2012.

Returning to FIG. 25, in step 2503, the facility materializes the document in a way that shows, in the context of the state of the document at the earlier time—i.e., near the end of the day on Jan. 2, 2012—the editing actions performed between the earlier time and the later time—i.e., near the middle of the day on Jan. 3, 2012. In step 2504, the facility displays the document materialization generated in step 2503. After step 2504, the facility continues in step 2502 to receive additional user input moving one or both sliders.

Returning to FIG. 26, it can be seen from author annotations 2621 and 2623 that authors Bill Hayes and Janice Moy performed editing actions during this range of time. It can also be seen that the document window 2630 contains a document state 2631 that reflects, by strikethrough, the deletion during this range of time of text present at the earlier time and, via underlining, the insertion during this range of time of text not present at the earlier time. In some embodiments, the facility uses color coding, or other similar schemes, to positively identify editing actions with the authors who took them.

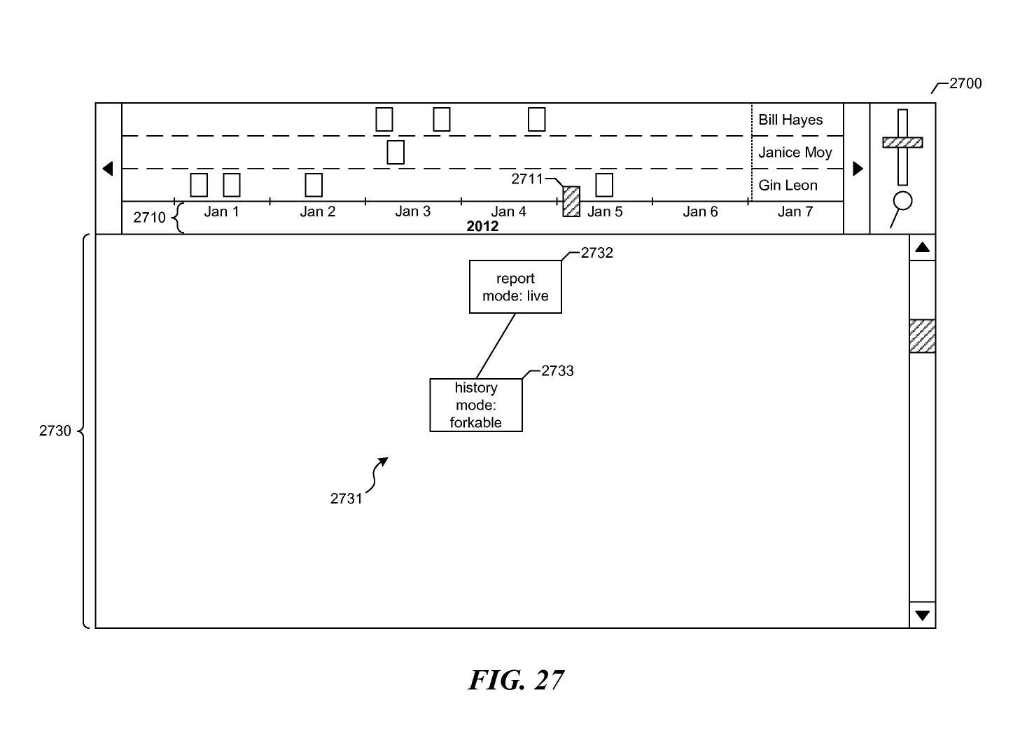

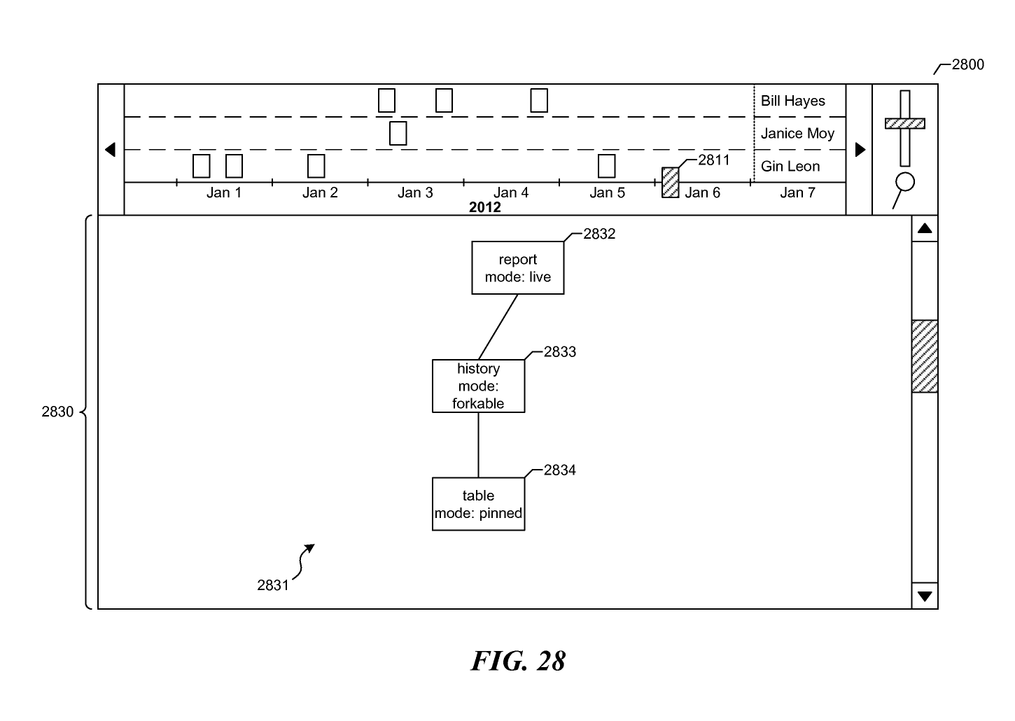

In various embodiments, the facility displays a variety of different kinds of visual representations of the document in the document window 2630. For example, as has been seen in FIGS. 19-24 and 26, in some embodiments, the visual representation of the document state displayed in the document window is the literal contents of the document. In some embodiments, the visual representation is a structural or organizational representation of the document. For example, the visual representation of the document state presented in the document window is a fragment graph showing the incorporation of fragments into the document. FIGS. 27 and 28 accordingly show changes to a document's fragment graph over time.

FIG. 27 is a display diagram showing a sample display presented by the facility in some embodiments to show the state of a document's fragment graph at a first time. It can be seen that the document window 2730 contains a fragment graph 2731 that was current for the document at the point in time selected by the slider 2711, early in the day on Jan. 5, 2012. The fragment graph has a root node 2732 that most centrally represents the document; it is a report fragment, and its mode is live, permitting it to be edited, both in that edits to the fragment in the context of this document will affect other documents that incorporate the same fragment in live mode, and in that edits to the fragment in the context of those other documents will affect this document. Fragment node 2732 has a child fragment node 2733 that has been incorporated into fragment node 2732. Node 2733 represents a history fragment, whose mode is forkable—that is, when this fragment was incorporated into the document, or at a later time, it was adjusted such that any editing action performed to the fragment in the context of this document would cause a new fragment to be substituted for this history fragment in this document. The new fragment is a fragment that reflects application of the editing action to the original fragment. This editing action and subsequent ones will be made to the new fragment and shown in the context of this document, but not in the context of other documents also incorporating the origin history fragment.

FIG. 28 is a display diagram showing a sample display presented by the facility in some embodiments to show the state of a document's fragment graph at a later time. In particular, the slider 2811 has been moved to select a time early in the day on Jan. 6, 2012, such that, relative to the state of the document shown in document window 2730 in FIG. 27, the state of the document shown in document window 2830 additionally reflects editing actions taken author Gin Leon on Jan. 5, 2012. It can be seen that those editing actions expanded the document's fragment graph 2831 to add to fragment node 2833 a child fragment node 2834. Fragment node 2834 represents a table fragment incorporated in the pinned mode—that is, this fragment was incorporated in the document in such a way that it state was fixed at a particular point in time; it is not editable in the context of this document, and changes to versions of it incorporated in other documents will have no effect on this document.

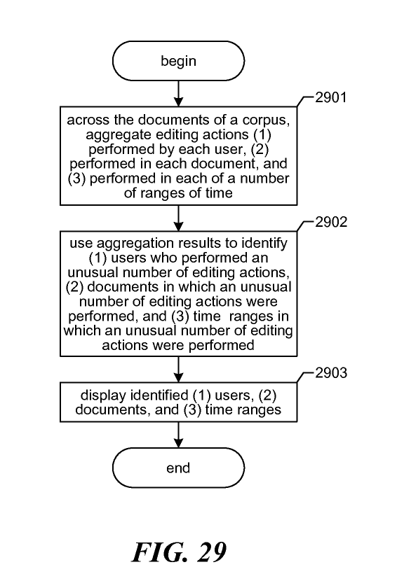

FIG. 29 is a flow diagram showing steps typically performed by the facility in some embodiments in order to generate analytics from document revision histories for a corpus of documents. In step 2901, across all of the documents in the corpus, the facility aggregates the editing actions performed by each user. For example, in various embodiments, the facility aggregates the number of editing actions performed by the user, the amount of time during which the user was performed editing actions that at least a certain minimum rate, etc. The facility further aggregates editing actions performed in each document. The facility further aggregates editing actions in each of a number of ranges of time, typically all of the same or similar length, such as each month, each week, each day, each hour, each minute, each second, etc. In step 2902, the facility uses the aggregation results obtained in step 2901 to identify users who performed an unusually large or small level of editing actions. The facility also uses these aggregation results to identify documents in which an unusually large or small level of editing actions were performed. The facility also uses these aggregation results to identify time ranges in which an unusually large or small level of editing actions were performed. In step 2903, the facility causes the users, documents, and time ranges identified in step 2902 to be displayed. In various embodiments, step 2903 involves displaying these results to a single user, or a group of users, in an application, on a webpage, or in a Twitter feed; sending an email, text message, or chat message; etc. to a user or group of users, etc. After step 2903, these steps conclude.

In various embodiments, the facility generates analytics of a variety of types with respect to fragments, documents of different types, groups of fragments, and/or groups of documents of different types. Some examples indicate analytics directed to: the number, frequency, or recency of creation of fragments or documents of other types; the number, frequency, or recency of edits; the number, frequency, or recency of comments; the number, frequency, or recency of views; the number, frequency, or recency of shares; the number, frequency, or recency of incorporations; number, frequency, or recency of forks; number, frequency, or recency of shares with other users; number, frequency, or recency of removals or deletions; number, frequency, or recency of approvals; number, frequency, or recency of promotions to a new status; number, frequency, or recency of locks for exclusive editing or unlocks to end exclusive editing; trends regarding other fragments authored by the same author; for a given document, trends regarding other documents that the author has authored or co-authored; number, frequency, or recency of security changes to a fragment or other document; such as adding or removing user permissions, trends regarding fragments or documents of other types defined as similar, such as by searching techniques, machine learning analysis, etc.

In some embodiments, a computing system for rendering a selected document that has changed over time is provided. The computing system comprises: a display subsystem configured to display concurrently (a) a timeline representing a period of time, (b) a first slider that is movable in response to user input to positions relative to the timeline each corresponding to a time during the first period of time, and (c) a document contents window; a document materialization subsystem configured to, for each position to which the first slider is moved, materialize at least a portion of the selected document as it existed at the time to which the position to which the first slider is moved corresponds; and a window population subsystem configured to, in response to each movement of the first slider to a position, populate the document contents window displayed by the display subsystem with the at least a portion of the selected document materialized by the document materialization subsystem for the position. Each of these subsystems is a computing-related entity, comprising either hardware, a combination of hardware and software, software, or software in execution on a computer.

In some embodiments, a computer-readable medium is provided having contents configured to cause a computing system to, in order to service a request for a document: receive the request, the request identifying the document and specifying a time for which the document is to be constituted; in response to receiving the request, access information representing a plurality of editing actions performed on the identified document, the accessed information indicating, for each of the represented plurality of editing actions, a time at which the editing action was performed on the identified document; and, also in response to receiving the request, respond to the request with a version of the identified document that reflects all of the represented editing actions whose indicated time is before the specified time, and that reflects none of the represented editing actions whose indicated time is after the specified time.

In some embodiments, a method in a computing system for analyzing a document corpus is provided. The method comprises: for each of a plurality of documents contained by the document corpus, accessing a comprehensive history of editing actions taken with respect to the document, the accessed history identifying for each editing action a person who performed the editing action on the document and a time at which the editing action was performed on the document; across the plurality of documents, aggregating the editing actions for at least one of (1) each person who performed an editing action, (2) each document, and (3) each of a plurality of ranges of time; and using results of the aggregation to identify at least one of (1) at least one person who performed an unusual number of editing actions, (2) at least one document with respect to which an unusual number of editing actions were performed, and (3) at least one of the plurality of ranges of time during which an unusual number of editing actions were performed.

### CONCLUSION

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

1. A computing system for rendering a selected document that has changed over time, comprising:
a display subsystem configured to display concurrently (a) a timeline representing a period of time, (b) a first slider that is movable in response to user input to positions relative to the timeline each corresponding to a time during the first period of time, and (c) a document contents window;
a document materialization subsystem configured to, for each position to which the first slider is moved, materialize at least a portion of the selected document as it existed at the time to which the position to which the first slider is moved corresponds; and
a window population subsystem configured to, in response to each movement of the first slider to a position, populate the document contents window displayed by the display subsystem with the at least a portion of the selected document materialized by the document materialization subsystem for the position.

2. The computing system of claim 1 wherein the display subsystem is configured to display the timeline annotated to show points in time at which editing actions were performed on the selected document.

3. The computing system of claim 1 wherein the display subsystem is configured to display the timeline annotated (1) to show points in time at which actions were performed on the selected document, and (2) to identify authors who performed actions at those points in time.

4. The computing system of claim 1 wherein the display subsystem is configured to display the timeline annotated (1) to show points in time at which actions were performed on the selected document, and (2) to identify portions of the document within which actions were performed at those points in time.

5. The computing system of claim 1 wherein the display subsystem is configured to display the timeline annotated (1) to show points in time at which actions were performed on the selected document, and (2) to indicate volumes of actions that were performed at those points in time.

6. The computing system of claim 1 wherein the display subsystem is configured to further concurrently display (d) a second slider that is movable in response to user input to positions relative to the timeline, the first slider and the second slider together defining a subrange of the first period of time represented by the timeline,
and wherein the at least a portion of the selected document that the document materialization subsystem is configured to materialize includes visual indications of editing actions performed on the document during the subrange of the first period of time represented by the timeline that is defined by the first slider and the second slider.

7. The computing system of claim 1 wherein the display subsystem is configured to further concurrently display (d) a control for scrolling the timeline to represent a second period of time different from the first period of time but the same length as the first period of time.

8. The computing system of claim 1 wherein the display subsystem is configured to further concurrently display (d) a control for zooming the timeline to represent a second period of time, the second period of time intersecting the first period of time and being of a different length than the first period of time.

9. The computing system of claim 1 wherein the display subsystem is configured to further concurrently display (d) a second timeline representing a third period of time including a time at which the document was created and each time an editing action was performed on the selected document, the second timeline containing a visual indication of the second period of time.

10. The computing system of claim 1 wherein the portion of the selected document that the document materialization subsystem is configured to materialize comprises literal contents of the selected document as it existed at the time to which the position to which the first slider is moved corresponds.

11. The computing system of claim 1 wherein the portion of the selected document that the document materialization subsystem is configured to materialize comprises a representation of how the selected document was organized at the time to which the position to which the first slider is moved corresponds.

12. The computing system of claim 1 wherein the identified document comprises a graph of document fragments, each document fragment of the graph being stored externally to the document,
and wherein the portion of the selected document that the document materialization subsystem is configured to materialize comprises a visual representation of the graph of document fragments at the time to which the position to which the first slider is moved corresponds.

13. A computer-readable medium having contents configured to cause a computing system to, in order to service a request for a document:
receive the request, the request identifying the document and specifying a time for which the document is to be constituted;
in response to receiving the request:
access information representing a plurality of editing actions performed on the identified document, the accessed information indicating, for each of the represented plurality of editing actions, a time at which the editing action was performed on the identified document; and
respond to the request with a version of the identified document that reflects all of the represented editing actions whose indicated time is before the specified time, and that reflects none of the represented editing actions whose indicated time is after the specified time.

14. The computer-readable medium of claim 13 wherein the contents of the computer-readable medium are configured to further cause a computing system to cause the version of the identified document with which the request is responded to be displayed.

15. The computer-readable medium of claim 13 wherein the identified document incorporates a document fragment stored externally to the document,
and wherein the accessing also accesses additional information representing a plurality of editing actions performed on the incorporated document fragment, the accessed additional information indicating, for each of the plurality of editing actions represented by the accessed additional information, a time at which the editing action was performed on the incorporated document fragment; and
and wherein the version of the identified document with which the request is responded to incorporates a version of the incorporated document fragment that reflects all of the editing actions represented by the accessed additional information whose indicated time is before the specified time, and that reflects none of the represented act editing actions whose indicated time is after the specified time.

16. A method in a computing system for analyzing a document corpus, comprising:
for each of a plurality of documents contained by the document corpus, accessing a comprehensive history of actions taken with respect to the document, the accessed history identifying for each action a person who performed the action on the document and a time at which the action was performed on the document;
across the plurality of documents, aggregating the actions for at least one of (1) each person who performed an action, (2) each document, and (3) each of a plurality of ranges of time; and
using results of the aggregation to identify at least one of (1) at least one person who performed an unusual number of actions, (2) at least one document with respect to which an unusual number of actions were performed, and (3) at least one of the plurality of ranges of time during which an unusual number of actions were performed.

17. The method of claim 16, further comprising causing the identified aspects to be displayed.

18. The method of claim 16 wherein, across the plurality of documents, the actions for each person who performed an action are aggregated, and wherein the results of the aggregation are used to identify at least one person who performed an unusual number of actions.

19. The method of claim 16 wherein, across the plurality of documents, the actions for each document are aggregated,
and wherein the results of the aggregation are used to identify at least one document with respect to which an unusual number of actions were performed.

20. The method of claim 16 wherein, across the plurality of documents, the actions for each of a plurality of ranges of time are aggregated, and wherein the results of the aggregation are used to identify at least one of the plurality of ranges of time during which an unusual number of actions were performed.
